(19) United States
(12) Patent Application Publication
(10) Pub. No.: US 2007/0288564 A1
(43) Pub. Date: Dec. 13, 2007

(54) Handling a message

(76) Inventors: Michael J. Rooke, Hyvinkaa (FI); Adamu Haruna, Tampere (FI)

Correspondence Address: HOLLINGSWORTH & FUNK, LLC;Suite 125, 8009 34th Avenue South, Minneapolis, MN, 55425, US

(21) Appl. No.: 11/513,569

(22) Filed: Aug. 31, 2006

(30) Foreign Application Priority Data
Jun. 7, 2006 (FI) 20060565

(51) Int. Cl. G06F 15/16

(52) U.S. Cl. 709/204

(57) ABSTRACT

In a chat, conference-related capability information on a recipient is maintained in the network; and when a message is received, a value corresponding to the conference-related capability information is determined, and a decision whether to send the message to the recipient or to store the message and send a link to the recipient is made on the basis of the outcome of a checking whether the value fulfils a preset condition relating to the conference-related capability information.

### FIELD OF THE INVENTION

The invention relates to conferencing between two or more participants, such as instant messaging, in a communications system.

### BACKGROUND OF THE INVENTION

The following description of background art may include insights, discoveries, understandings or disclosures, or associations together of disclosures, that were not known to the relevant art prior to the present invention but which were provided by the invention. Some such contributions of the invention may be specifically pointed out below, whereas other such contributions of the invention will be apparent from their context.

The evolvement of communication technology, particularly IP-based communication technology and end user terminals, has enabled versatile communication possibilities and introduction of different services. More and more often services are implemented using primitives provided by SIP (Session Initiation Protocol) which is not vertically integrated into a communications system but a tool to build a multimedia architecture. More precisely, SIP is an IETF defined application-layer control (signaling) protocol for creating, modifying, and terminating sessions with one or more participants. Herein, conferencing and a conference cover a session between two or more participants. These sessions include Internet telephone calls, multimedia distribution, multimedia conferences, and instant messaging, for example. For messaging services, SIMPLE (SIP for Instant Messaging and Presence Leveraging Extensions) using SIP and existing implementations of SIP to provide presence and instant messaging service is being defined in IETF. OMA (Open Mobile Alliance) also defines an IM (Instant Messaging) enabler based on SIP/SIMPLE protocols. Chat is instant messaging provided by using SIP for signaling and session establishment and MSRP (Message Session Relay Protocol) for carrying a series of instant messages, as one-to-one or one-to-many communication, after a session has been established. For a chat, participants may set up a chat room, which is a virtual place to exchange messages and means the same as a session-based instant messaging conference. Chat rooms may be public, i.e. open to all, or they may be private, i.e. the participation is restricted to given users. The basic principle of a chat is that a participant in the chat may send a message (an instant message) to one or more recipients so that they receive the message substantially simultaneously and each recipient may respond to the message.

### SUMMARY

The invention relates to a method, server components, a conferencing application unit and a computer readable medium which are defined in the independent claims. The preferred embodiments of the invention are disclosed in the dependent claims.

In a general aspect, implementations may include utilizing information on at least one conference capability, which is negotiated when a participant joins a conference, and a corresponding condition relating to the capability to determine whether to forward the message or to store the message and send a link, i.e. a reference or pointer to physical data on a storage volume, instead. An example of a conference capability is a maximum size of a message that a participant is willing to, or can, receive during a chat. A link may be a uniform resource locator or a uniform resource indicator, for example.

### BRIEF DESCRIPTION OF THE DRAWINGS

In the following embodiments will be described in greater detail with reference to the attached drawings, in which

FIG. 1 shows a simplified system architecture;

FIG. 2 is a simplified block diagram of a server according to an embodiment of the invention; and

FIGS. 3 to 8 are flow charts illustrating a functionality of a server according to embodiments of the invention.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment.

The present invention is applicable to any communications system or any combination of different communications systems that is/are accessible by user terminals and provide(s) instant messaging services, i.e. sending data in a message format from one entity to another in real time or near real time. No limitations exist to the message format, neither to the data type. The data may be text, voice, video clips, multimedia, etc. The communications system may be a fixed communications system or a wireless communications system or a communications system utilizing both fixed networks and wireless networks. The protocols used, the specifications of communications systems and terminals, especially in wireless communications, develop rapidly. Such development may require extra changes to the invention. Therefore, all words and expressions should be interpreted broadly and they are intended to illustrate, not to restrict, the invention.

In the following, the present invention will be described using, as an example of a system environment whereto the present invention may be applied, a very simplified system environment utilizing SIP and MSRP and providing instant messaging, i.e. near real time interchange of messages of two or more users in a communications network, wherein users join a chat session individually, without restricting the invention thereto. It should be appreciated that the communications system and the intermediate nodes, such as proxies, and other protocols used below or above SIP and MSRP, or corresponding protocols, are irrelevant to the actual invention. Therefore, they need not be discussed in more detail here.

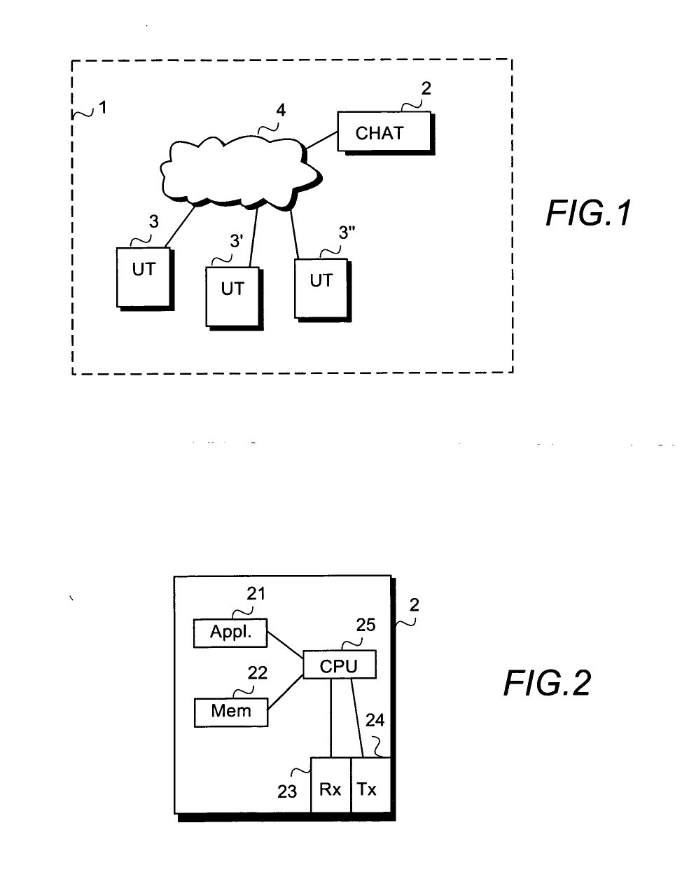

FIG. 1 is a highly simplified system architecture only showing a communications system 1, a network 4 to which an apparatus configured as a server 2 is connected and user terminals UT 3, 3′, 3″ may connect. It is apparent to a person skilled in the art that the system(s) also comprise(s) other devices, system entities, such as intermediate network nodes routing and transmitting messages, functions and structures that need not be described in detail herein.

A user terminal 3, 3′, 3″ is a piece of equipment or a device that allows a user to interact with a communications system directly or via a computer system, that is, it presents information to the user and allows the user to input information, i.e. the user terminal is a termination point of particular communication. In other words, the user terminal 3, 3′, 3″ may be any node or a host which supports messaging and is able to communicate with a network of the system over an access network (not shown in FIG. 1) if such an access network exists. However, the implementation of instant messaging in a user terminal is irrelevant to the invention, and is therefore not discussed here in detail.

The apparatus 2 is configured, in this example, to be a conference server, and more precisely, a chat server connected to the network and represents here different servers, or network nodes comprising server components and service applications that provide conferencing, and preferably instant messaging, or corresponding services. The server may be configured as a computer including at least a memory for providing storage area used for arithmetic operation and an operation processor for executing the arithmetic operation. An example of the operation processor includes a central processing unit.

FIG. 2 is a simplified block diagram of an apparatus 2 configured as a server according to an embodiment of the invention and will be called server below. The server 2 is a chat server that is preferably a focus, i.e. maintains a SIP signaling relationship with each participant in the chat, is responsible for ensuring that each participant receives the media that make up the chat, and implements chat policies. The server 2 comprises one or more messaging application (Appl.) units 21 according to an embodiment of the invention, called a messaging application below, memory (Mem) 22, a receiver (Rx) 23 for receiving and a transmitter (Tx) 24 for sending communications (messages) and one or more operation processors 25 for processing one or more messaging applications, for processing and controlling receiving and sending communications and for controlling the use of the memory. It is apparent to a person skilled in the art that the server may comprise other components, entities, functions and structures that need not be described in detail herein.

The messaging application 21, which in the illustrated example is a chat service application and illustrates different conferencing applications, may be a software application or a module, or any other corresponding means, configured to implement a functionality according to an embodiment of the invention. In other words, the messaging application unit 21 may be configured as the arithmetic operation, or as a program, executed by the operation processor. The functionality may be achieved by updating a corresponding messaging application or by adding a new messaging application to the server, for example. The application according to an embodiment of the invention may be shipped with the server, or it may be a downloadable plug-in to the server, otherwise later added to the server, or an application in the server may be modified to be an application according to an embodiment of the invention.

The memory 22 may be storage suitable for storing messages at least temporarily. In some other embodiments of the invention, instead of, or in addition to, the memory 22, the server is arranged to have access to another memory or other corresponding storage for storing messages at least temporarily. Thus, the storage may be in the server or remote from the server. It suffices that user terminals may obtain messages from the storage and the messages may be stored therein. However, the actual implementation of the storage is irrelevant to the invention, and is therefore not discussed here in detail. Capabilities negotiated by a participant when joining a conference are preferably maintained in the memory 22 but they may be maintained in another memory to which the server is arranged to have access. The negotiated capabilities are below called conference-related capability information.

In other words, the servers or corresponding server components or units and/or other corresponding devices implementing the functionality of an embodiment of the present invention comprise not only prior art means but also means for deciding whether to send a message or to store the message and send a link in a manner that will be described below. More precisely, they comprise means for implementing an embodiment of the invention and they may comprise separate means for each step, or means may be configured to perform two or more steps. Present servers comprise processors and memory that can be utilized in the functions according to an embodiment of the invention. All modifications and configurations required for implementing the invention may be performed as routines, which may be implemented as added or updated software routines, application circuits (ASIC) and/or programmable circuits. Software routines, also called program products, including applets and macros, can be stored in any device-readable data storage medium and they include program instructions to perform particular tasks. Software routines may be downloaded into a device (server).

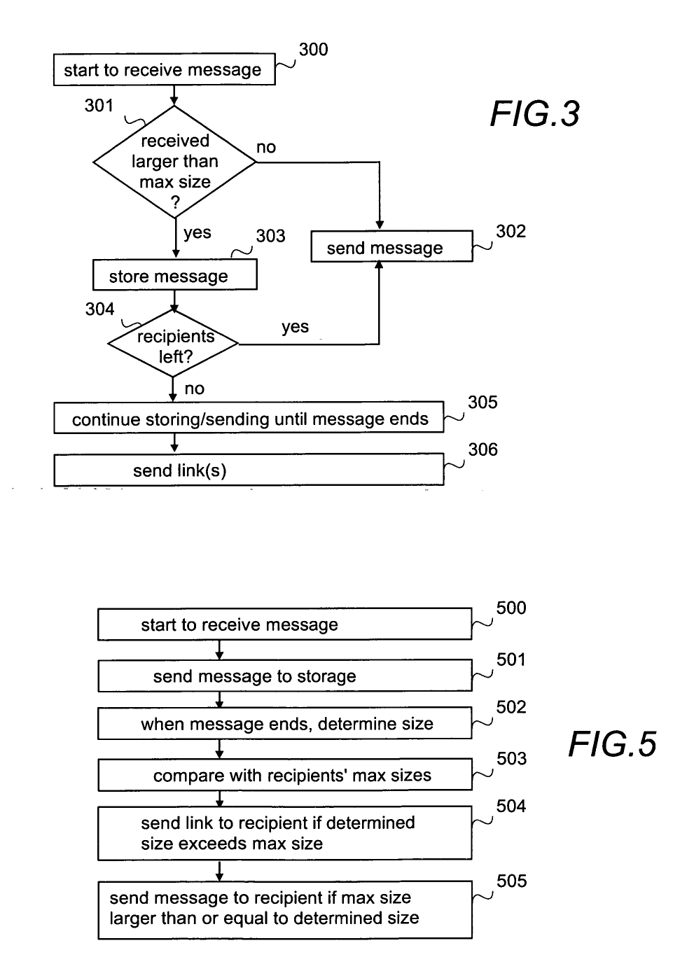

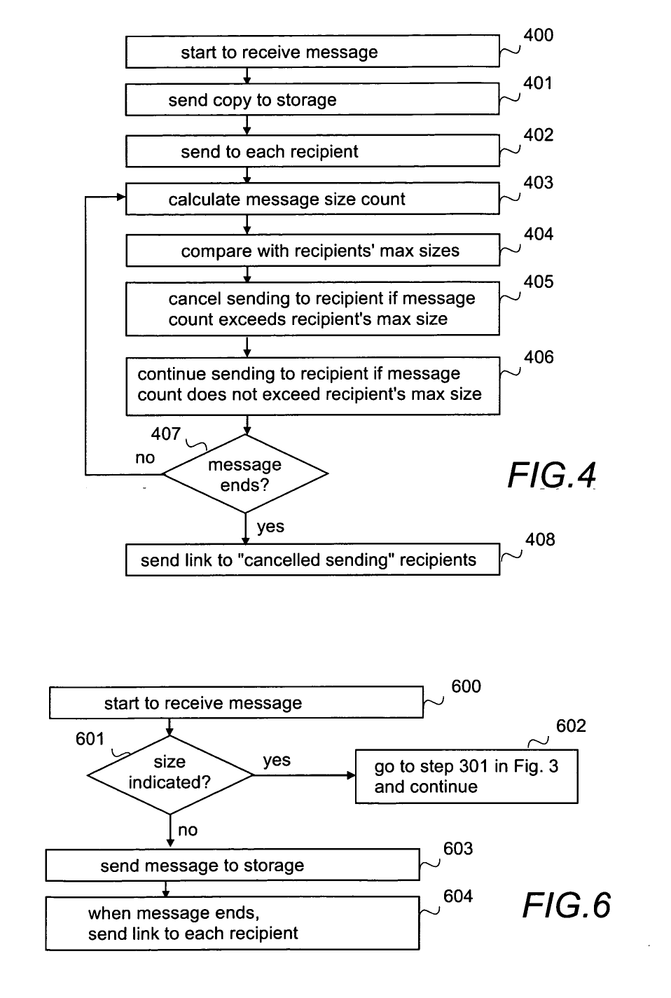

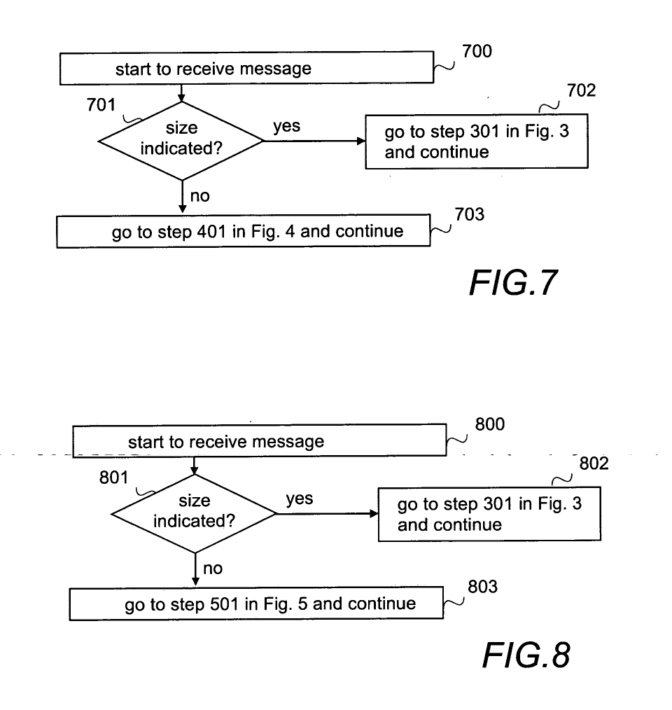

Different embodiments of the server functionality, or more precisely a messaging application functionality, are disclosed below with FIGS. 3 to 8. The embodiments will be described using as the conference-related capability information a recipient-specific maximum message size, and as the condition that a size of a received message should not exceed the maximum message size, without restricting the invention thereto. Other properties of a message can be used instead of, or in addition to, the size, as the conference-related capability information, such as content type, presentation type or presentation format. Although the examples illustrate message-related capability information, other conference-related capability information may be used as well. Accordingly, the condition may relate to the other properties, and/or there may be several conditions which may relate to the same capability. A further example of a condition is that a presentation format needs to be indicated as acceptable, or unacceptable, by the participant. Another example of a size-related condition is that the size of a message has to be larger than a preset minimum value and smaller than or equal to the maximum message size.

In all disclosed embodiments it is assumed, for the sake of clarity, that a chat session has been established, each participant has indicated the maximum message size it supports, for example, is willing to receive, during initial SIP negotiation when the participant joins the chat, and the server has stored the maximum size chat-specifically and recipient-specifically. It is also assumed, for the sake of clarity, that the decision whether to send a message or a link to a recipient is made recipient-specifically. However, it is obvious to one skilled in the art how to implement the invention, if all recipients receive the message exactly in the same way, i.e. the decision is made based on the smallest indicated maximum message size. In situations in which a participant does not indicate the maximum message size, zero, unlimited, another default value, smallest among indicated, largest among indicated, median of indicated, average of indicated, for example, can be used as his/her maximum message size. In other words, there are no restrictions what to use as the maximum message size if it is not indicated. A further assumption made here is that the message is received as a byte stream, for example as an “MSRP SEND (byte stream)”, and sending a message, as well as storing a message, means here that the received byte stream is forwarded as received. A link may be sent in an “MSRP SEND (content indirection)”. Recipients cover here participants to whom the message is targeted. Typically all participants other than the sender of the message are recipients but, since chat-type messaging also provides private messaging within a chat room, recipients may be a sub-set of participants, or even one participant.

FIG. 3 discloses an embodiment in which all messages indicate their size. The size may be indicated in a header, for example, in a byte-range header field in an MSRP SEND, or by sending advance information on the size of a following message. Thus, the server is able to determine the size without receiving the whole message.

FIG. 3 starts when the server starts, in step 300, to receive a message. The server then takes the recipient's maximum message size, and compares it, in step 301, with the indicated size of the received message. If the received message is not larger than the maximum message size (step 301), the server sends, in step 302, the message to the recipient. If the received message is larger than the maximum message size (step 301), the server stores, in step 303, the message in storage. Then the server checks, in step 304, whether there are any unchecked recipients left. If there is, the server takes the next recipient's maximum message size and compares it, in step 301, with the indicated size of the received message. Steps 301 to 304 are repeated until the check in step 301 has been performed on each recipient. When the check has been performed on each recipient (step 304), the server continues, in step 305, storing and/or sending the message until the message ends, i.e. until the byte stream of the incoming message is completed. After that the server sends, in step 306, each recipient to whom the message was not sent, a link to the stored message in the storage. By receiving the link, the recipient knows that a message is deferred and obtainable and the recipient can decide whether or not to obtain it. Naturally, if the message is smaller than any maximum message size, nothing is preferably stored, and no link sent.

In another embodiment of the invention, the server is configured to first check whether or not the indicated size of the received message is larger than the smallest maximum size of the participants, and if not, to send the message without performing the above steps, and to perform the above steps if the message size is larger than the smallest maximum size.

In another embodiment of the invention, the message is stored only once but a link is sent to each recipient to whom the message was not sent.

FIGS. 4 and 5 illustrate embodiments in which a message size is not determined in advance. Thus, they are particularly suitable if all messages do not indicate their size, for example if it is possible to use an asterisk/asterisks as a message size indicator, or if a message size cannot be indicated.

FIG. 4 starts when the server starts, in step 400, to receive a message. The server sends, in step 401, a copy of the message to a storage. In other words, the server buffers, or stores, the message. Preferably at the same time, the server sends, in step 402, the message to the recipients. While receiving and sending, the server calculates, in step 403, a message size count which indicates the size of the received portion of the message. The message size count is compared, in step 404, with the recipients' maximum message sizes recipient-specifically, and if the message size count exceeds an individual maximum message size, the sending of the message to the recipient whose maximum message size was exceeded is cancelled in step 405, while sending to other recipients is continued (step 406). Canceling means preferably that the remaining bytes of the message are not sent. Steps 403 to 406 are repeated until the message ends (step 407), i.e. the byte stream of the incoming message is completed. When the message has ended (step 407), the server sends, in step 408, each recipient to whom the message sending was cancelled, a link to the stored message in the storage. By receiving the link, the recipient knows that a message is deferred and obtainable and the recipient can decide whether or not to obtain it. Naturally, if nothing was cancelled, no link is sent and the buffer may be emptied.

FIG. 5 illustrates an embodiment which, compared with the embodiment in FIG. 4, introduces some delay to sending but has the advantage that there is no need to count the message and keep the state of the count for each recipient. Thus, it requires less processing.

FIG. 5 starts when the server starts, in step 500, to receive a message. The server sends, in step 501, a copy of the message to storage. In other words, the server buffers, or stores, the message. When the message ends (step 502), the server determines the size of the received message and compares, in step 503, the determined size with the recipients' maximum message sizes recipient-specifically. In other words, the comparison is performed on each recipient using individual maximum message sizes. If the determined size exceeds an individual maximum message size of a recipient, a link to the stored message in the storage is sent, in step 504, to the recipient whose maximum message size was exceeded. By receiving the link, the recipient knows that a message is deferred and obtainable and the recipient can decide whether or not to obtain it. If the determined size does not exceed an individual maximum message size of a recipient, the server sends, in step 505, the stored message to the recipient. This sending may be performed so that the server initiates a new MSRP SEND to the recipient in which the “From” header field will preferably contain the same URI (uniform resource identifier) as the received message, i.e. the original sender's URI, not the server's URI.

In an embodiment, when the message is buffered in step 501 temporarily, the message is preferably stored more permanently, or sent to a permanent storage in step 504.

FIGS. 6 to 8 illustrate embodiments in which a message may, or may not, indicate its size, and the messages are processed according to whether or not they indicate the size. In other words, they illustrate embodiments of a server which may or may not determine the size from the message. FIGS. 6 to 8 illustrate only some combinations of some of the above embodiments, and it is obvious to one skilled in the art that other combinations of the above embodiments are also possible.

FIG. 6 starts, when the server starts, in step 600, to receive a message. The server checks, in step 601, whether or not the message size is indicated, i.e. whether it can be determined. If the message size is indicated (step 601), the server continues processing the message according to the embodiment disclosed in FIG. 3 (step 602). In other words, the server performs the step 301 illustrated above and continues therefrom as illustrated above with FIG. 3. If the message size is not indicated, the server sends, in step 603, the message to storage and when the message ends, the server sends, in step 604, a link to each recipient. Thus, each recipient receives the message, or information on the message, nearly simultaneously.

An embodiment illustrated in FIG. 7 is a combination of embodiments illustrated with FIGS. 3 and 4. FIG. 7 starts when the server starts, in step 700, to receive a message. The server checks, in step 701, whether or not the message size is indicated, i.e. whether it can be determined. If the message size is indicated (step 701), the server continues processing the message according to the embodiment disclosed in FIG. 3 (step 702). In other words, the server performs the step 301 illustrated above and continues therefrom as illustrated above with FIG. 3. If the message size is not indicated (step 701), the server continues processing the message according to the embodiment disclosed in FIG. 4 (step 703). In other words, the server performs the step 401 illustrated above and continues therefrom as illustrated above with FIG. 4.

An embodiment illustrated in FIG. 8 is a combination of embodiments illustrated with FIGS. 3 and 5. FIG. 8 starts when the server starts, in step 800, to receive a message. The server checks, in step 801, whether or not the message size is indicated, i.e. whether it can be determined. If the message size is indicated (step 801), the server continues processing the message according to the embodiment disclosed in FIG. 3 (step 802). In other words, the server performs the step 301 illustrated above and continues therefrom as illustrated above with FIG. 3. If the message size is not indicated (step 801), the server continues processing the message according to the embodiment disclosed in FIG. 5 (step 503). In other words, the server performs the step 501 illustrated above and continues therefrom as illustrated above with FIG. 5.

As stated above, the invention is applicable with other kinds of conditions. For example, if a recipient has not indicated SMIL (synchronised multimedia integration language) as an acceptable presentation format, messages with SMIL will be stored and a link will be sent, as described above with FIGS. 3 to 8. Another example is that messages with SMIL or exceeding a negotiated maximum size will be stored and a link will be sent.

Although in the above it is assumed, for the sake of clarity, that one message is received at a time, messages may overlap in a chat. Depending on the implementation, the server either processes overlapping messages as if each of them were the only one received, or the messages may be put in a processing queue. Nevertheless, the messages may be processed according to an embodiment of the invention, and preferably independently of each other. For example, while a message is being stored, another message may be sent.

It is also possible that it depends on the received message which embodiment the server implements, i.e. the server may be configured to implement two or more different embodiments, wherein the selection which embodiment to use may depend on a preset condition, or when a chat is established, the embodiments are offered as alternatives, one of which is selected by a participant, for example.

The steps shown in FIGS. 3 to 8 are in no absolute chronological order and some of the steps may be performed simultaneously or in an order different from the given one. Other functions can also be executed between the steps or within the steps. For example, while storing a message, the server may send some information to recipients, such as a “IsComposing” SIP message. Some of the steps or parts of the steps can also be left out or replaced by a corresponding step or part of the step. For example, instead of storing a whole message, the content of the message may be stored. The steps can also be freely combined or divided into several parts.

Although in the above the invention has been disclosed assuming that the messaging is one-to-many messaging, it is obvious to one skilled in the art that the messaging may as well be one-to-one messaging.

Although in the above the invention has been disclosed assuming that one server stores the capability information on a chat session and decides whether to send a message or a link, it is obvious to one skilled in the art that the storing and deciding may be decentralized to other servers or network nodes. For example, the capability information may be maintained in each recipient's serving messaging server.

It will be obvious to one skilled in the art that, as the technology advances, the inventive concept can be implemented in various ways. The invention and its embodiments are not limited to the examples described above but may vary within the scope of the claims.

1. A method comprising:
maintaining conference-related capability information on a recipient;
determining, in response to receiving a message, a value corresponding to the conference-related capability information;
deciding whether to send the message to the recipient or to store the message and send a link to the recipient by checking whether the value fulfils a preset condition relating to the conference-related capability information; and
continuing message handling according to the decision.

2. A method according to claim 1, wherein the message is part of instant messaging, and the maintaining and deciding is performed recipient-specifically.

3. A method according to claim 1, wherein, in response to the message failing to indicate its value, the message is stored and a link is sent to the recipient.

4. A method according to claim 1, the method further comprising:
buffering the message until it is completely received;
determining the value of the buffered message; and
using the determined value when making the decision.

5. A method according to claim 1, the method further comprising:
in response to the message indicating its value, using the value when making the decision; and
in response to the message not indicating its value, buffering the message until it is completely received, determining the value of the buffered message, and using the determined value when making the decision.

6. A method according to claim 1, wherein the conference-related information is message-related information.

7. A method according to claim 6, wherein the message-related information is a maximum message size indicated by the recipient; the condition is that if the size of the message exceeds the maximum message size, the message is stored and a link is sent; and the value is the size of the message.

8. A method according to claim 7, the method further comprising:
storing the message;
sending the message to the recipient;
calculating during the sending a message count indicating a size of a sent part of the message;
using the message count as the value;
performing the checking during the sending; and
if the message count exceeds the maximum value;
cancelling the sending; and
sending a link to the recipient.

9. A method according to claim 7, wherein the method further comprises
in response to the message indicating its size, using the size when making the decision; and
in response to the message not indicating its size:
storing the message;
sending the message to the recipient;
calculating during the sending a message count indicating a size of a sent part of the message;
using the message count as the value;
performing the checking during the sending; and
if the message count exceeds the maximum value;
cancelling the sending; and
sending a link to the recipient.

10. A computer readable medium having computer-executable components comprising:
maintaining conference-related capability information on a recipient;
determining, in response to receiving a message, a value corresponding to the conference-related capability information;
deciding whether to send the message to the recipient or to store the message and send a link to the recipient by checking whether the value fulfils a preset condition relating to the conference-related capability information; and
continuing message handling according to the decision.

11. A computer-readable medium as claimed in claim 10, further comprising maintaining and deciding is performed recipient-specifically.

12. A server component comprising at least
memory configured to contain conference-related capability information on participants of a conference
a receiver configured to receive messages from the participants
an operation processor capable to access the memory for storing and obtaining information, and configured to be responsive to the receiver, to make a decision by using the conference-related capability information, a preset condition relating to the conference-related capability information, and a value of a message, the value corresponding to the conference-related capability information, and to act according to the decision, the decision being whether to send a message to a recipient or to store the message and send a link to the recipient; and
a transmitter configured to send the outcome of the decision.

13. A server component according to claim 12, wherein the operation processor is further configured to make the decision recipient-specifically using recipient's conference-related capability information.

14. A server component according to claim 12, wherein the operation processor is further configured, in response to a message whose value cannot be determined without receiving the whole message, to store the message to the memory and decide to send a link to the recipient.

15. A server component according to claim 12, wherein the operation processor is further configured to buffer the message until it is completely received; to determine the value of the buffered message; and to use the determined value when making the decision.

16. A server component according to claim 12, wherein the operation processor is further configured, to detect whether or not a value of a message can be determined without receiving the whole message, and
in response to a message whose value cannot be determined without receiving the whole message, to buffer the message until it is completely received; to determine the value of the buffered message; and to use the determined value when making the decision: and
in response to the message whose value can be determined without receiving the whole message, to use the value when making the decision.

17. A server component according to claim 13, wherein the operation processor is further configured, to detect whether or not a value of a message can be determined without receiving the whole message, and
in response to a message whose value cannot be determined without receiving the whole message, to buffer the message until it is completely received; to determine the value of the buffered message; and to use the determined value when making the decision: and
in response to the message whose value can be determined without receiving the whole message, to use the value when making the decision.

18. A server component according to claim 12, wherein the operation processor is further configured to use as conference-related capability information a maximum message size indicated by the recipient, and as the condition that if the size of the message exceeds the maximum message size, the message is stored and a link is sent, and as the value the size of the message; and, in response to a message whose value cannot be determined without receiving the whole message, to store the message; to send the message to the recipient; to calculate during the sending a message count indicating a size of a sent part of the message; to use the message count as the value; to perform the deciding during the sending; and, in response to the message count exceeding the maximum value, to cancel the sending; and to send a link to the recipient.

19. A conferencing application unit capable to access memory containing contain conference-related capability information on participants of a conference and configured to be responsive to a message received from a participant of the conference, to obtain conference-related capability information, to make a decision by using the conference-related capability information, a preset condition relating to the conference-related capability information, and a value of a message, the value corresponding to the conference-related capability information, and to send instructions according to the decision, the decision being whether to send a message to a recipient or to store the message and send a link to the recipient.

20. A conferencing application unit according to claim 18, the conferencing application unit being an instant messaging application providing a chat service.

21. A server component comprising
maintaining means for maintaining conference-related capability information on participants of a conference;
receiving means for receiving messages from the participants;
means for making a decision by using the conference-related capability information, a preset condition relating to the conference-related capability information, and a value of a message, the message being received from a participant of a conference, the value corresponding to the conference-related capability information; and
means for acting according to the decision, the decision being whether to send a message to a recipient or to store the message and send a link to the recipient.

22. A server component according to claim 20, further comprising means for buffering the message until it is completely received; means for determining the value of the buffered message; wherein the means for making a decision are configured to use the determined value when making the decision.

23. A server component according to claim 20, further comprising means for detecting a message whose value cannot be determined without receiving the whole message, wherein the means for making a decision are configured to be responsive to the means for detecting, and to store the message to the memory and decide to send a link to the recipient.
